(19) United States
(12) Patent Application Publication
(10) Pub. No.: US 2008/0069074 A1
(43) Pub. Date: Mar. 20, 2008

(54) SUCCESSIVE INTERFERENCE CANCELLATION FOR MULTI-CODEWORD TRANSMISSIONS

(75) Inventors: Sung-Hyuk Shin, Northvale, NJ (US); Chang-Soo Koo, Melville, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/857,019

(22) Filed: Sep. 18, 2007

Related U.S. Application Data
(60) Provisional application No. 60/825,977, filed on Sep. 18, 2006.

(51) Int. Cl. H04B 7/216

(52) U.S. Cl. 370/342

(57) ABSTRACT

A method of signal processing in a wireless transmit receive unit (WTRU) including multiple input/multiple output (MIMO) functionality. The method includes the WTRU receiving a plurality of simultaneous signals, performing a first process on at least one of the plurality of simultaneous signals, transmitting a feedback signal based on the first process, and performing a second process on at least one of the plurality of simultaneous signals. The first process is a subset of the second process.

### CROSS REFERENCE TO RELATED APPLICATION

This application claims the benefit of U.S. Provisional application No. 60/825,977, filed Sep. 18, 2006, which is incorporated by reference as if fully set forth.

### FIELD OF INVENTION

The present invention relates generally to wireless communications. More particularly, a method and apparatus for successive interference cancellation (SIC) for multi-codeword transmissions is disclosed.

### BACKGROUND

The Third Generation Partnership Project (3GPP) is an industry group working to improve world-wide wireless communication. Its Long Term Evolution (LTE) project is looking to set standards and guidelines to improve wireless communication systems in the near and long-term future.

One of the technologies being considered for LTE is Multiple Input/Multiple Output (MIMO). MIMO involves the use of multiple antennas on both the transmitter side and the receiver side. A technology commonly used in MIMO systems is Per Antenna Rate Control (PARC), which is a method for individually adjusting the data rate for each antenna Another technology being considered is multi-codeword transmission. Typically, in an LTE MIMO system, multi-codeword transmission is implemented by transmitting each codeword over a different antenna. Furthermore, hybrid automatic repeat request (HARQ) is an error detection and correction method that is typically used in LTE. In general, error detection information along with an error correction code is encoded with each transmitted data block. The error detection is often a cyclic redundancy check (CRC). Lastly, successive interference cancellation (SIC) may be used in MIMO systems to distinguish between simultaneous signals by successively using one set of interference cancelled signals to process a next set of signals. SIC methods may provide error free signals, but require processing time.

Combining multi-codeword transmission, PARC, CRC, and SIC in a single wireless transmit receive unit (WTRU) may provide a spectrally efficient and robust product. However, LTE specifies 5-msec user-plane latency. In order to meet this specification, WTRU processing time would need to be about 2 to 3 msec for HARQ reception, processing and acknowledgement/non-acknowledgement (ACK/NACK) generation. The result may be that the WTRU exceeds the requirements for maximum processing time.

FIG. 1 is a flow chart of a full SIC method in accordance with the prior art. At step 102, a signal is received by a WTRU. At step 104, the WTRU selects two HARQ processes for processing. At step 106, the WTRU checks to see if one of the HARQ processes is a retransmission. If the signal contains a retransmission, at step 108, the retransmitted HARQ processes are combined. If the WTRU determines that the signal does not contain a retransmitted HARQ process, step 108 is skipped. In either case, the signal is decoded at step 110, and, at step 112, a CRC is performed.

If the HARQ process passes the CRC, at step 114 the ACK/NACK signal is set to ACK, and full SIC is performed at step 116, removing one of the HARQ components from the signal. If the signal fails, the ACK/NACK is set to NACK at step 118. The counter is incremented, and the method returns to step 104.

FIG. 2 is a continuation of FIG. 1. Once the first two HARQ processes are processed as in method 100 of FIG. 1, at step 202, the WTRU determines if the ACK/NACK signal for HARQ(1) is a NACK, and HARQ(2) is an ACK. If not, the ACK/NACK is transmitted to a Node-B in an uplink (UL) signal.

However, if HARQ(1) generated a NACK and HARQ(2) generated an ACK, HARQ(1) is recoded at step 206 and at step 208, a CRC is performed on HARQ(1). If the signal passes CRC, the ACK/NACK signal is set to ACK at step 212 and an ACK for HARQ(1) and HARQ(2) is transmitted at step 214. If HARQ(1) again fails CRC, then a NACK is transmitted for HARQ(1) at step 214.

The processing required for method 100 is typically very complex and time consuming. The processing time for a 2×2 multi-codeword transmission with full SIC may be up to twice that as for a single codeword. This processing time may exceed the LTE specified maximum limits. Furthermore, as the number of codewords increases, it becomes less likely that the processing time will be less than the maximum allowed by LTE specifications. Further, in a wireless system using 2×2 PARC MIMO, full SIC processing may increase the WTRU processing time by up to twice that of a receiver without full SIC processing. Therefore, it would be desirable to have a method for multi-codeword SIC processing that will not exceed the timing requirements of LTE.

### SUMMARY

a method and apparatus for signal processing in a WTRU are disclosed. The WTRU may include multiple input/multiple output (MIMO) functionality. The method may include, but is not limited to, the WTRU receiving a plurality of simultaneous signals, performing a first process on at least one of the plurality of simultaneous signals, transmitting a feedback signal based on the first process, and performing a second process on at least one of the plurality of simultaneous signals.

### BRIEF DESCRIPTION OF THE DRAWINGS

A more detailed understanding may be had from the following description of a preferred embodiment, given by way of example and to be understood in conjunction with the accompanying drawings wherein:

FIGS. 1 and 2 are flow diagrams of a full SIC method for a typical 2×2 MIMO PARC multi-codeword wireless system in accordance with the prior art;

FIG. 3 shows an exemplary wireless communication system in accordance with one embodiment;

FIG. 4 is a functional block diagram of the wireless communication system 300 of FIG. 3.

FIG. 5 is a block diagram of a method of hybrid SIC in accordance with one embodiment;

FIGS. 6 and 7 are flow diagrams of the hybrid SIC method in accordance with one embodiment;

FIG. 8 is diagram showing an example of the hybrid SIC method in accordance with one embodiment as applied to a typical HARQ signal; and

FIG. 9 shows a timing diagram for an N-process stop and wait (SAW) HARQ method in accordance with an alternative embodiment.

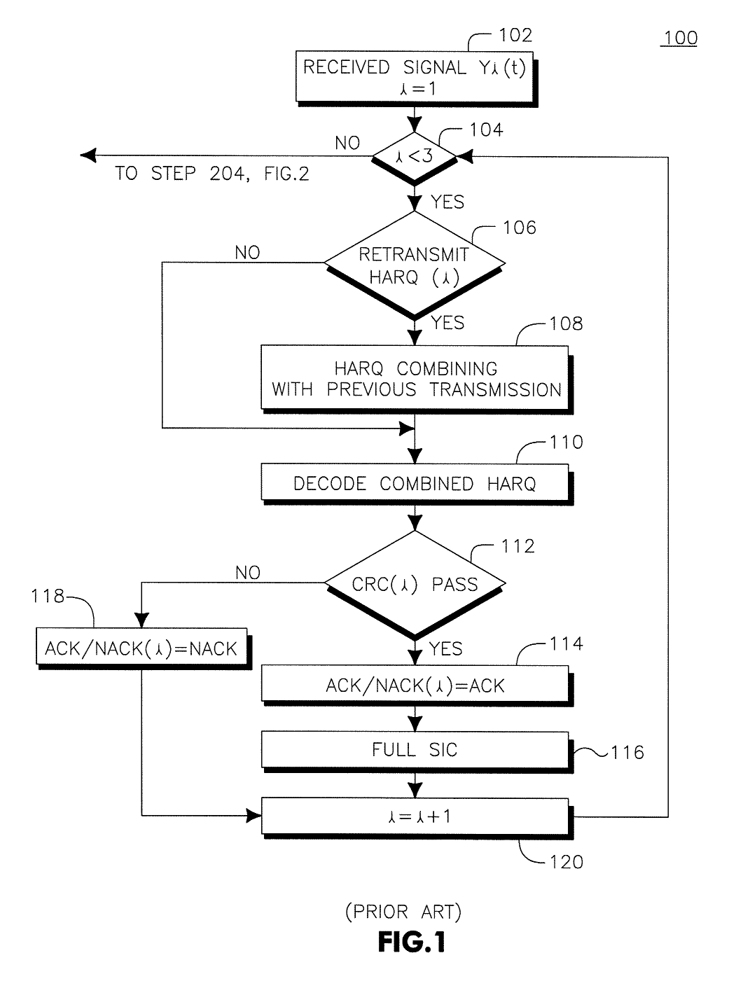

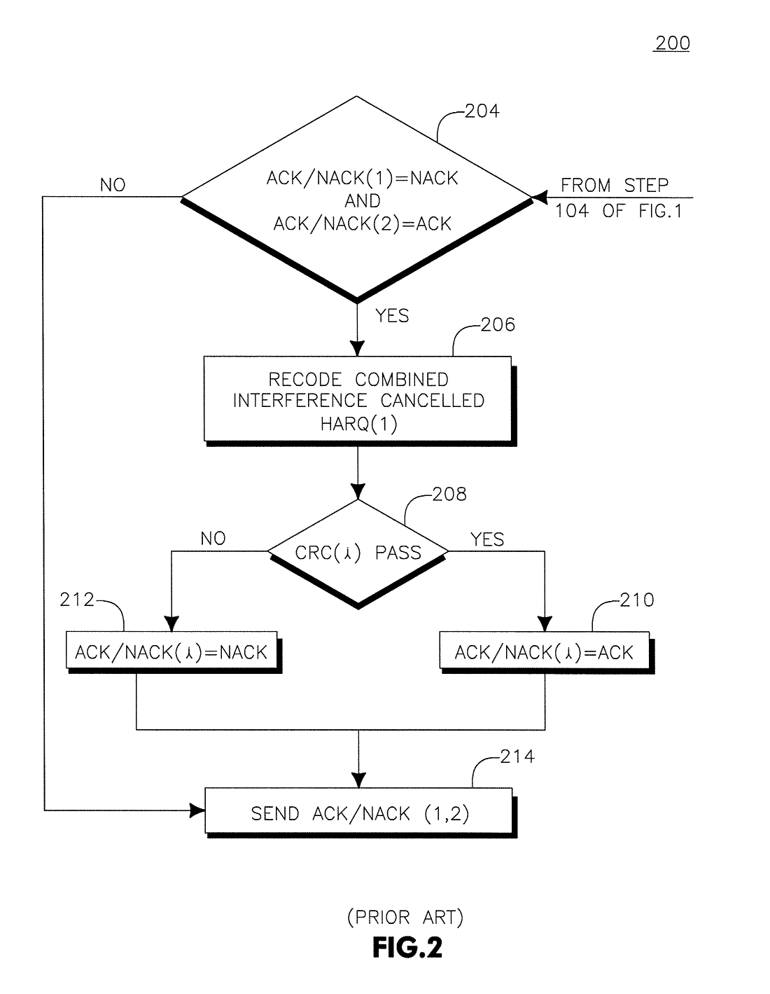

### DETAILED DESCRIPTION OF THE PREFERRED EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment

Local SIC, as used herein, includes SIC before decoding or without signal reconstruction via the transmitter channel coding chain. The resulting “soft” ACK/NACK signal is transmitted within the timing requirement to a NodeB. A “soft” ACK/NACK signal means that a NACK result may be reversed to ACK once full SIC is applied after the soft ACK/NACK is transmitted.

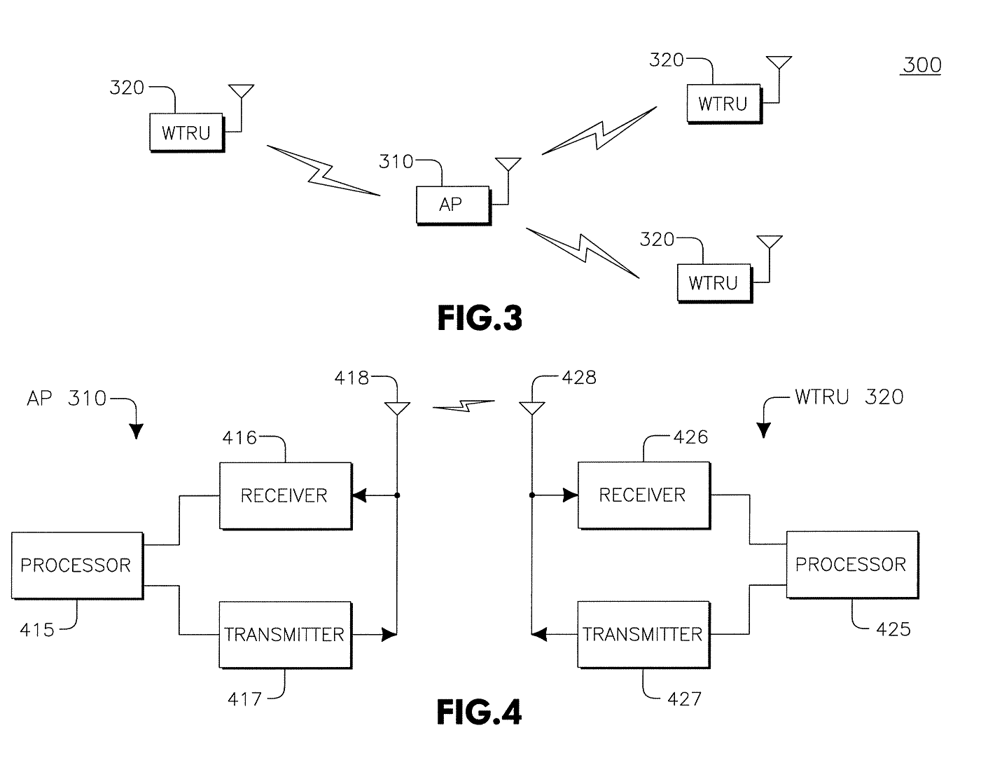

Turning now to FIG. 3, there is shown an exemplary wireless communication system 300, which includes a plurality of wireless communication devices, such as an AP 310 and a plurality of WTRUs 320, capable of wirelessly communicating with one another. Although the wireless communication devices depicted in the wireless communication system 300 are shown as APs and WTRUs, it should be understood that any combination of wireless devices may comprise the wireless communication system 300. That is, the wireless communication system 300 may comprise any combination of APs, WTRUs, stations (STAs), and the like. An AP may be a Node-B, a base station, and the like.

For example, the wireless communication system 300 may include an AP and client device operating in an infrastructure mode, WTRUs operating in ad-hoc mode, nodes acting as wireless bridges, or any combination thereof. However, the wireless communication system 300 may be any other type of wireless communication system.

FIG. 4 is a functional block diagram of an AP 310 and a WTRU 320 of the wireless communication system 300 of FIG. 3. As shown in FIG. 4, the AP 310 and the WTRU 320 are in wireless communication with one another. In addition to the components that may be found in a typical AP, the AP 310 includes a processor 415, a receiver 416, a transmitter 417, and an antenna 418. The processor 415 is configured to generate, transmit, and receive data packets. The receiver 416 and the transmitter 417 are in communication with the processor 415. The antenna 418 is in communication with both the receiver 416 and the transmitter 417 to facilitate the transmission and reception of wireless data. The antenna 418 may be a plurality of antennas.

Similarly, in addition to the components that may be found in a typical WTRU, the WTRU 320 includes a processor 425, a receiver 426, a transmitter 427, and an antenna 428. The processor 425 is configured to generate, transmit, and receive data packets. The receiver 426 and the transmitter 427 are in communication with the processor 425. The antenna 428 is in communication with both the receiver 426 and the transmitter 427 to facilitate the transmission and reception of wireless data.

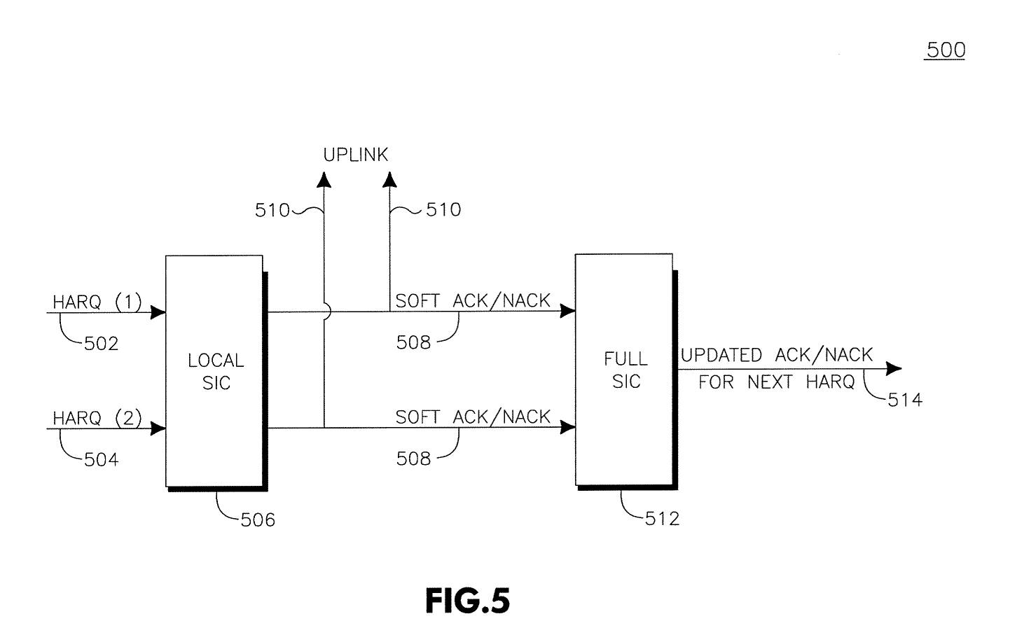

FIG. 5 is a block diagram of a hybrid SIC method in accordance with one embodiment. HARQ(1) 502 and HARQ(2) 504 are received at a WTRU. The WTRU performs a local SIC 506. Local SIC 506 is a SIC process that is performed before the HARQ signals 502, 504 are decoded. The local SIC function 506 generates a soft ACK/NACK 508 that is transmitted on the uplink 510 to satisfy LTE timing requirements. After a full decoding and SIC process is performed, the soft ACK/NACK 508 may be reversed. The soft ACK/NACK 508 is processed in a full SIC function 512, producing an updated ACK/NACK 514 that may be used for the next HARQ.

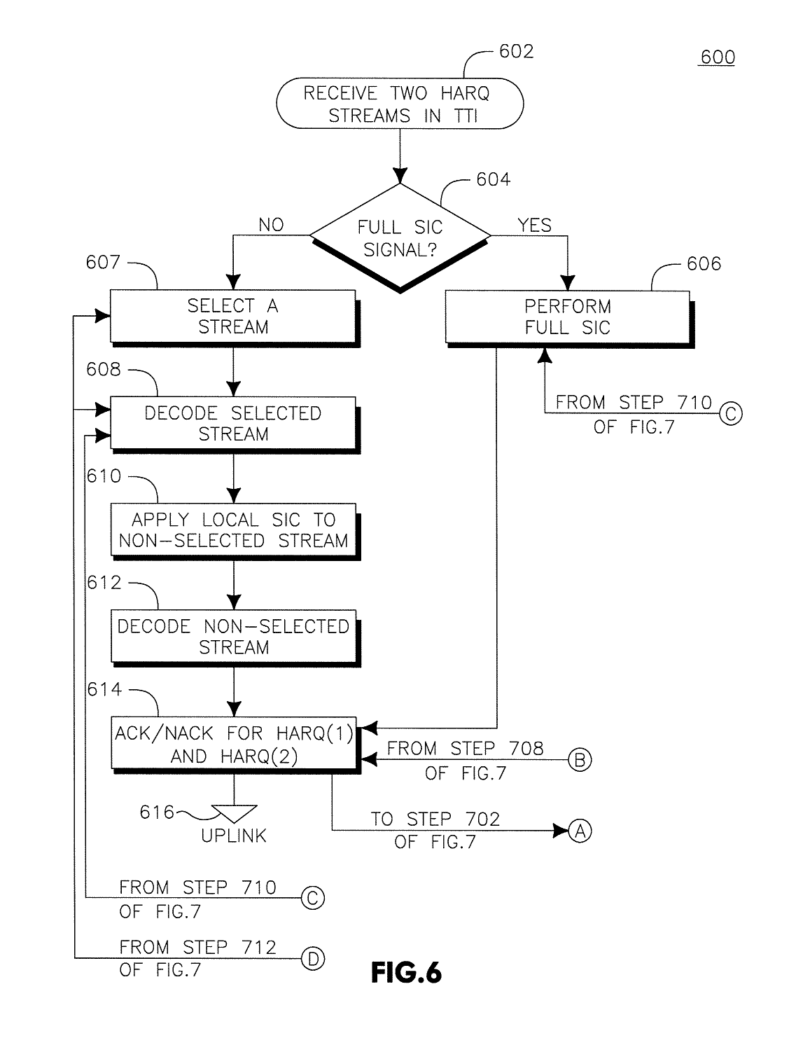

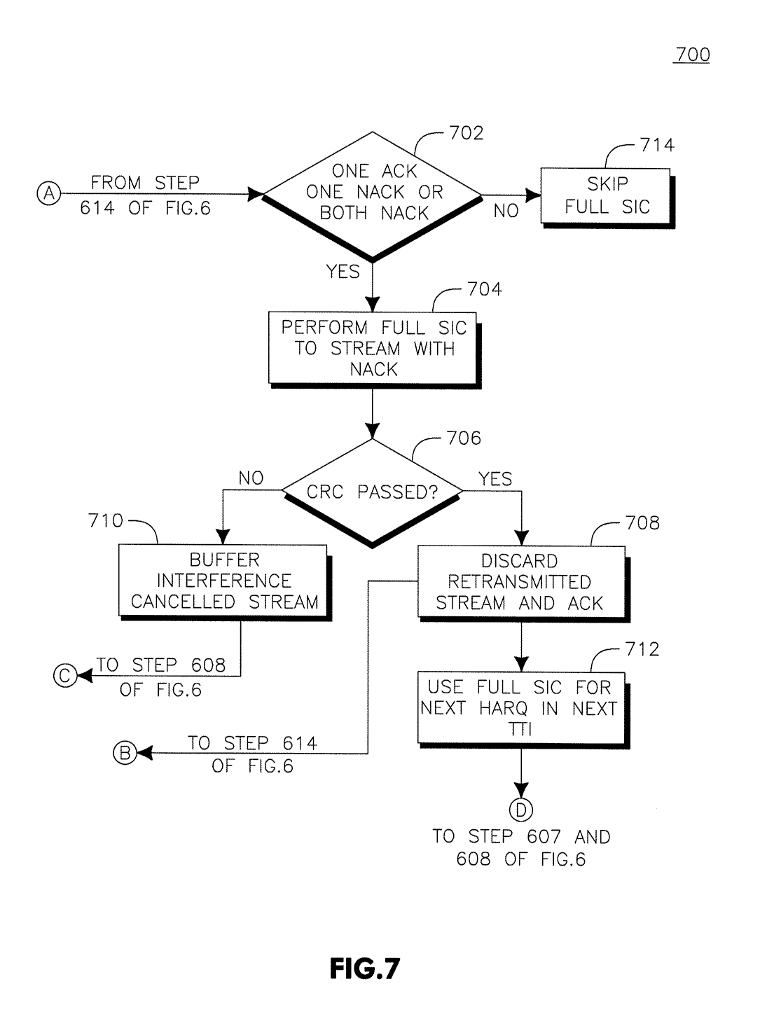

FIG. 6 is a flow diagram for a hybrid SIC method in accordance with one embodiment. At step 602, two HARQ processes are received by a WTRU. At step 604, the WTRU determines if the HARQ processes require full SIC processing. Full SIC processing is required for a new HARQ if a soft ACK/NACK from the previous associated HARQ processing was reversed.

If full SIC processing is required, the WTRU performs full SIC processing at step 606. If full SIC processing is not required, the WTRU selects one of the HARQ streams for processing at step 607. The selected stream is decoded at step 608. At step 610, a local SIC process is applied to the non-selected stream. The local SIC process includes removing a contribution of the selected stream from the non-selected stream. At step 612, the interference cancelled non-selected stream is decoded.

A step 614, the WTRU performs a CRC check on either the full SIC signal or the local SIC signal and an ACK/NACK is generated for both HARQ processes. The ACK/NACK is transmitted on an uplink channel, at step 616, to satisfy the LTE timing requirements. Simultaneously, both HARQ signals continue to be processed as shown in FIG. 7.

Referring to FIG. 7, once the signal has been processed with a local SIC procedure, the WTRU determines at step 702 if, (after the CRC check), one of the HARQ processes generated a NACK. If not, full SIC is not necessary and is skipped at step 714. If one of the HARQ processes generates a NACK, full SIC is applied to the signal that generated the NACK at step 704. At step 706, CRC check is performed again. If the signal passes the CRC check, at step 708, the corresponding retransmitted signal from a subsequent transmission time interval (TTI) is discarded and an ACK is generated for the uplink transmission. At step 712, the signal is saved for use in the SIC process for a subsequent TTI. If the HARQ fails at step 706, the interference cancelled stream is buffered at step 710 and the method returns to FIG. 6.

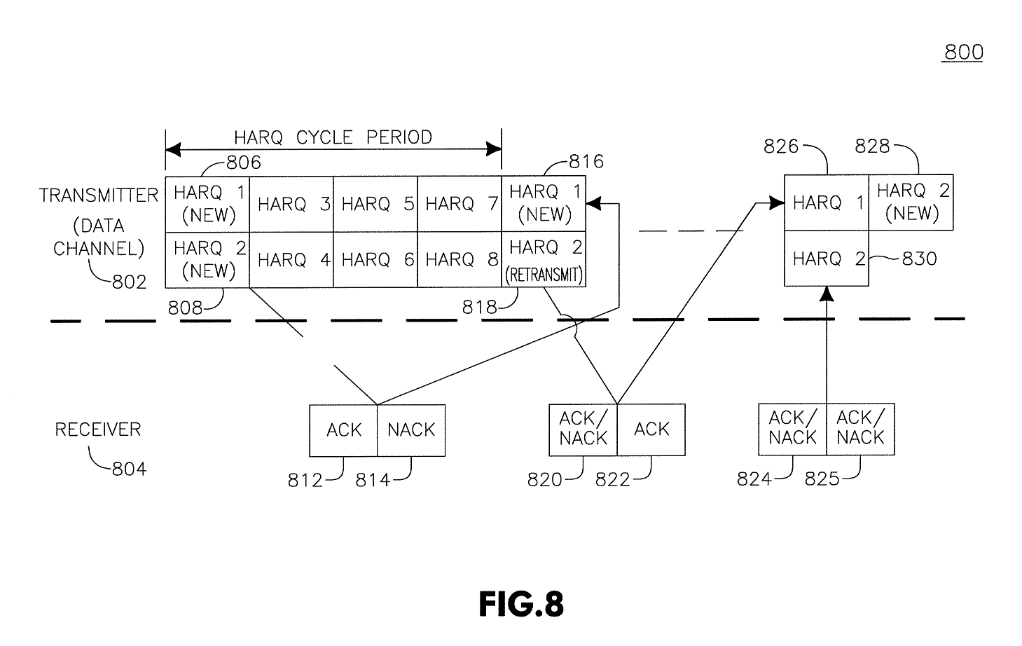

FIG. 8 is diagram showing an example of the hybrid SIC method in accordance with one embodiment as applied to a typical HARQ signal. Two (2) HARQ processes, HARQ1 806 and HARQ2 808 are simultaneously transmitted from a transmitter 802 to a receiver 804. The receiver 804 decodes the signal, performs a local SIC, and generates the appropriate ACK/NACK for each. In this example, HARQ1 806 is successfully received (CRC passes) but HARQ2 808 is not. Therefore, an ACK 812 is sent back to the transmitter 802 for HARQ1 806, and a NACK 814 is transmitted for HARQ2 808.

Since the ACK 812 was sent back to the transmitter 802 for HARQ1 806, the next HARQ1 816 is new. Additionally, because a NACK 814 was returned for HARQ2 808, the next HARQ2 818 is a retransmission of the first HARQ2 808. Also, the contribution of HARQ1 is removed from HARQ2 808 and a CRC is applied to HARQ2 808. If HARQ2 808 passes the CRC, an ACK is returned for HARQ2 808 and HARQ2 808 is used for a full SIC that is performed on the next HARQ received by the receiver. In the example shown in FIG. 8, the appropriate ACK/NACK 820 is returned for HARQ1 816, and an ACK 822 is returned for HARQ2 818, which is the retransmitted HARQ2 808.

FIG. 8 is an example of a local SIC process being applied to a HARQ signal and the local SIC process resulting in a NACK. Then, a full SIC process being applied to the same HARQ process after the NACK is returned to the transmitter. The full SIC process results in a change of the NACK to an ACK.

The next HARQ1 826 is then transmitted, which may be new if an ACK was returned, or retransmitted if a NACK was returned. Also, a new HARQ2 828 is transmitted.

If, however, HARQ2 808 fails the CRC after a full SIC is applied, a HARQ recombining and local SIC is applied using HARQ1 806. Depending upon the outcome of a CRC, an appropriate ACK/NACK 824 is returned to the transmitter 802 for HARQ1, and an appropriate ACK/NACK 825 is returned for HARQ2. Based on the ACK/NACKs 824,825 the next HARQ1 826 and next HARQ2 830 may be new, or may be retransmissions. Using this method 800, an ACK/NACK is returned after each HARQ cycle period, although the receiver may still be processing the HARQ signals after the HARQ cycle period is complete.

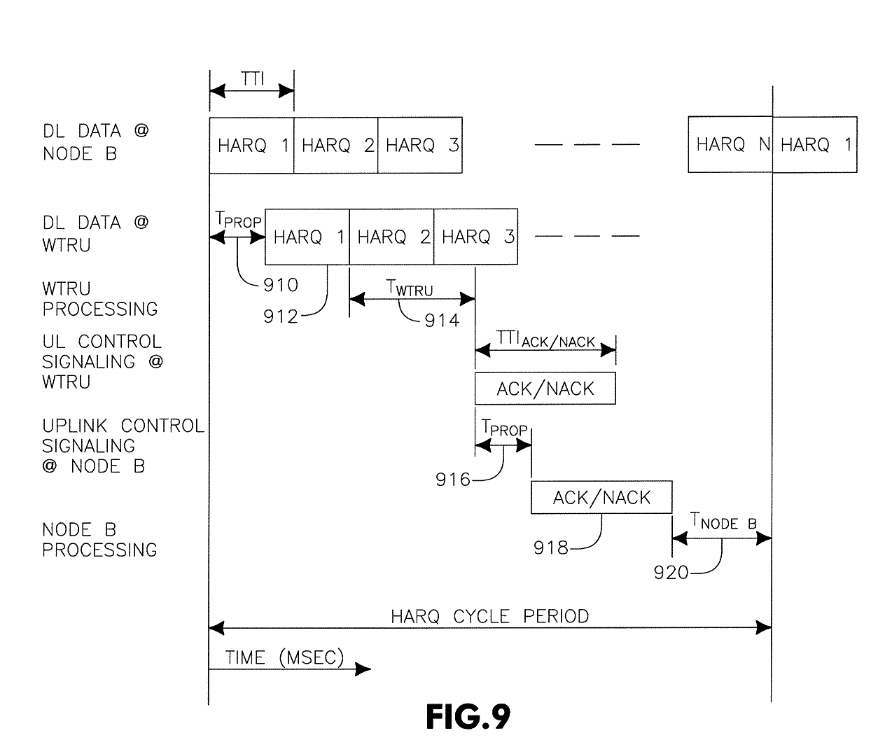

FIG. 9 shows a timing diagram for an N-process stop and wait (SAW) HARQ method 900 in accordance with an alternative embodiment. Each HARQ process takes one TTI. Moving from left to right and top to bottom in FIG. 9, a total HARQ cycle period equals a: 1) HARQ TTI 912; 2) propagation delay 910; 3) WTRU processing time 914; 4) second propagation delay 916; 5) ACK/NACK TTI 918; and 6) Node-B processing time 920. If N is less than or equal to eight (8), in order to meet the LTE requirement for user plane latency of less than five (5) msec, total processing time for the WTRU and the Node-B should be less than or equal to 2 to 3 msec. In order to implement SIC processing at either the WTRU or the node-B, the hybrid method disclosed herein may be used.

Although the features and elements are described in the embodiments in particular combinations, each feature or element can be used alone without the other features and elements of the preferred embodiments or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of signal processing in a wireless transmit receive unit (WTRU) including multiple input/multiple output (MIMO) functionality, the method comprising:
the WTRU receiving a plurality of simultaneous signals;
the WTRU performing a first process on at least one of the plurality of simultaneous signals;
the WTRU transmitting a feedback signal based on the first process; and
the WTRU performing a second process on at least one of the plurality of simultaneous signals, wherein the first process is a subset of the second process.

2. The method as in claim 1 wherein the plurality of simultaneous signals comprises a plurality of hybrid automatic repeat request (HARQ) processes.

3. The method as in claim 1 wherein the first process comprises a local successive interference cancellation (SIC) process and the second process comprises a full SIC process.

4. The method as in claim 3 wherein the local SIC process comprises interference cancellation without decoding.

5. The method as in claim 1 wherein the feedback signal is an acknowledge/non-acknowledge s (ACK/NACK) signal.

6. A method of performing successive interference cancellation (SIC) for a multi-codeword transmission in a wireless transmit receive unit (WTRU), the method comprising:
the WTRU receiving a first hybrid automatic repeat request (HARQ) process stream and a second HARQ process stream in a given transmission time interval (TTI);
the WTRU applying a local SIC process to the first and second HARQ processes; and
the WTRU transmitting a first feedback signal based on the local SIC process.

7. The method of claim 6 further comprising the WTRU performing a full SIC process on one of the first HARQ process or the second HARQ process after transmitting the first feedback signal.

8. The method of claim 6 wherein the first feedback signal comprises an acknowledge/non-acknowledge (ACK/NACK).

9. The method as in claim 7 further comprising the WTRU transmitting a second feedback signal to replace the first feedback signal after the full SIC process is performed.

10. The method as in claim 6 further comprising the WTRU selecting one of the first HARQ process or the second HARQ process based on a received power strength measure.

11. The method as in claim 10 further comprising the WTRU decoding the selected HARQ process and performing a local SIC on the non-selected HARQ process using the decoded HARQ process.

12. The method as in claim 6 wherein local SIC comprises successive interference cancellation before decoding.

13. The method as in claim 6 wherein local SIC comprises successive interference cancellation without signal reconstruction.

14. The method as in claim 6 wherein the method is performed within a specified time period.

15. A method of processing a plurality of hybrid automatic repeat request (HARQ) signals in a multiple input/multiple output (MIMO) configured wireless transmit receive unit (WTRU) configured to receive and transmit multi-codeword signals, the method comprising:
the WTRU simultaneously receiving a first HARQ signal and a second HARQ signal,
the WTRU selecting and decoding one of the first HARQ signal or the second HARQ signal based on a received signal strength;
the WTRU performing a local successive interference cancellation (SIC) process on the non-selected HARQ by removing a contribution of the selected HARQ signal from the non-selected HARQ signal;
the WTRU decoding the non-selected HARQ signal; and
the WTRU transmitting a first acknowledge/non-acknowledge (ACK/NACK) signal to a Node-B.

16. The method as in claim 15 further comprising the WTRU performing a full SIC process to at least one of the first and second HARQ signal based on the ACK/NACK signal.

17. The method as in claim 16 further comprising the WTRU transmitting a second ACK/NACK signal to the Node-B based on the full SIC process.

18. The method as in claim 17 wherein the second ACK/NACK signal is different than the first ACK/NACK signal.

19. The method as in claim 17 further comprising the WTRU simultaneously receiving a third HARQ signal and a fourth HARQ signal, wherein at least one of the third HARQ signal and fourth HARQ signal comprises a retransmission of at least on e of the first HARQ signal and the second HARQ signal based on the first ACK/NACK signal.

20. A wireless transmit receive unit (WTRU) comprising:
a plurality of antennas;
a receive function configured to simultaneously receive a first HARQ process and a second HARQ process; and
a first SIC function configured to select either of the first or second HARQ processes and perform interference cancellation on the non-selected HARQ process without decoding.

21. The WTRU as in claim 20 further comprising:
a second SIC function configured to perform a full successive interference cancellation process on one of the first HARQ process or the second HARQ process.

22. The WTRU as in claim 20 further comprising a per antenna rate control function.

23. The WTRU as in claim 20 wherein the first and second SIC functions each comprise an acknowledge/non-acknowledge (ACK/NACK) signal generator.

24. The WTRU as in claim 23 wherein the first SIC function is configured to generate a first ACK/NACK signal within a specified time.

25. The WTRU as in claim 23 wherein the second SIC function is configured to generate a second ACK/NACK signal to replace the first ACK/NACK signal.
